(19) United States
(12) Patent Application Publication
(10) Pub. No.: US 2005/0081920 A1
(43) Pub. Date: Apr. 21, 2005

(54) Valve unit for modulating the delivery pressure of a gas

(76) Inventors: Filiberto Rimondo, Saonara (IT); Roberto Dorigo, Caorle (IT)

Correspondence Address: RATNERPRESTIA, P O BOX 980, VALLEY FORGE, PA, 19482-0980, US

(21) Appl. No.: 10/502,671

(22) PCT Filed: Jan. 29, 2002
(86) PCT No.: PCT/IT02/00044

(51) Int. Cl. G05D 7/06

(52) U.S. Cl. 137/487.5

(57) ABSTRACT

A valve unit for modulating the delivery pressure of a gas. The valve unit delivers a gas flow and has a servo-valve with a first closure element and a tapping duct. The valve unit further has a pressure regulator associated with the servo-valve and including a valve seat mounted in the tapping duct and a respective second closure element associated with the seat, as well as an actuator associated with the second closure element, and a control circuit for generating a control signal for the actuator. The movement of the second closure element relative to the corresponding valve seat is correlated proportionally with the actuator-control signal so that, for a pre-selected signal value, a corresponding control-pressure value is generated so as to modulate the delivery pressure in a proportionally correlated manner.

### TECHNICAL FIELD

The present invention relates to a valve unit for modulating the delivery pressure of a gas.

### TECHNOLOGICAL BACKGROUND

Valve units of the type indicated are used widely for controlling the delivery of a fuel gas to a burner or other similar user, particularly but not exclusively in heating apparatus.

In these units, it is known to regulate the delivery pressure (and consequently the flow rate) of the gas in a controlled manner by modulation between a minimum pressure and a maximum pressure performed by a servo-valve which is subservient to a modulation unit with a diaphragm. The servo-valve typically comprises a closure element which can be opened by a diaphragm that is sensitive to the pressure differential existing between the pressure in the delivery duct and a control pressure. This control pressure is controlled by the operation of a modulation valve.

A valve unit having the above-mentioned characteristics is known from the Applicant's European application EP 1058060. In this application, the actuator of the modulation valve is controlled by an oscillating control signal (for example, an electrical voltage signal) with a predetermined “duty cycle” in order consequently to generate an oscillating control-pressure signal the integrated mean value of which is a function of the pre-selected “duty cycle.” A limitation which may be encountered in the above-mentioned valve unit lies in the fact that the control-pressure value which is sensitive to the modulation is represented by a mean value of the pressure reached within a certain period of time, so that, by its very nature, the gas delivery-pressure regulation function is rendered less accurate.

Moreover, the control of the modulation valve is quite complex since it requires a control circuit which is arranged to control the regulation of the “duty cycle” during the valve-modulation operation.

### SUMMARY OF THE INVENTION

The main object of the present invention is to provide a valve unit which ensures improved and more accurate modulation control of the gas-delivery pressure, achieved by a modulation valve and a respective actuator for the operation thereof with a simplified structure but at the same time such as to overcome the limitations discussed with reference to the prior art mentioned.

This object and others which will become more clear from the following description are achieved by providing a valve unit formed in accordance with the present invention.

### BRIEF DESCRIPTION OF THE DRAWINGS

Further characteristics and advantages of the invention will become more clear from the following detailed description of a preferred embodiment thereof, described by way of non-limiting example, with reference to the appended drawings, in which:

FIG. 1 is a schematic longitudinal section through a valve unit formed in accordance with the invention,

FIG. 2 is a view corresponding to that of FIG. 1, of a variant of the invention,

FIG. 3 is a schematic block diagram of a second variant of the valve unit according to the invention,

FIG. 4 is a view corresponding to that of FIG. 3, of a further variant of the invention,

FIG. 5 is a section through a detail of the valve unit of the preceding drawings,

FIG. 6 is a graph of a characteristic pressure-voltage curve of the valve unit according to the embodiment of FIG. 3, and

FIG. 7 is a graph of a characteristic pressure-voltage curve of the valve unit according to the embodiment of FIG. 4.

### PREFERRED EMBODIMENT OF THE INVENTION

With reference initially to FIG. 1, a valve unit according to the present invention for modulating the delivery pressure of a fuel gas delivered to a burner or other similar user, not shown in the drawing, is generally indicated 1. The fuel gas is supplied in the unit 1 through a main duct 2 between an inlet opening 3 and an outlet opening 4.

The valve unit 1 also comprises a servo-valve 5 mounted in the main duct 2 and including a closure element 6 which is urged resiliently into closure on a valve seat 7 by the resilient load of a spring 7a and can be opened by a diaphragm 8 which is sensitive to the pressure differential existing between the pressure Pu at the outlet 4, on one side, and the pressure Pt in a control chamber 9, on the other side. The control-pressure value Pt is controlled by the operation of a pressure-regulation device, generally indicated 10 and described in detail below.

The unit 1 also has a safety valve 11 disposed in the duct 2, upstream of the pressure regulator 10 and controlled, for example, by an electromagnetic unit (not shown) of conventional structure for shutting off the gas-flow in the duct 2 in the absence of a power supply to the electromagnetic unit controlling the safety valve.

The control chamber 9 is in flow communication with the main duct 2 through a tapping duct 12 for tapping off gas, with opposed ends 12a, 12b. At the end 12a, the tapping duct 12 opens into the main duct 2, upstream of the servo-valve 5.

The control chamber 9 also communicates with the outlet opening 4 of the duct 2 through a transfer duct 13 having a constriction 14 in the region of the opening 4. Moreover, a delivery nozzle disposed at the outlet 4 of the unit, downstream of the constriction 14, is indicated 14a.

The pressure regulator 10 comprises a valve seat 15 formed in the tapping duct 12, preferably in the region of the end 12a, and a corresponding closure element 16 which is moved so as to close/open the valve seat 15 by an actuator generally indicated 17. The actuator 17 is preferably of the piezoelectric type, for example, of the type comprising a double metal plate 18 extending along a predominant longitudinal axis between opposed ends 18a, 18b.

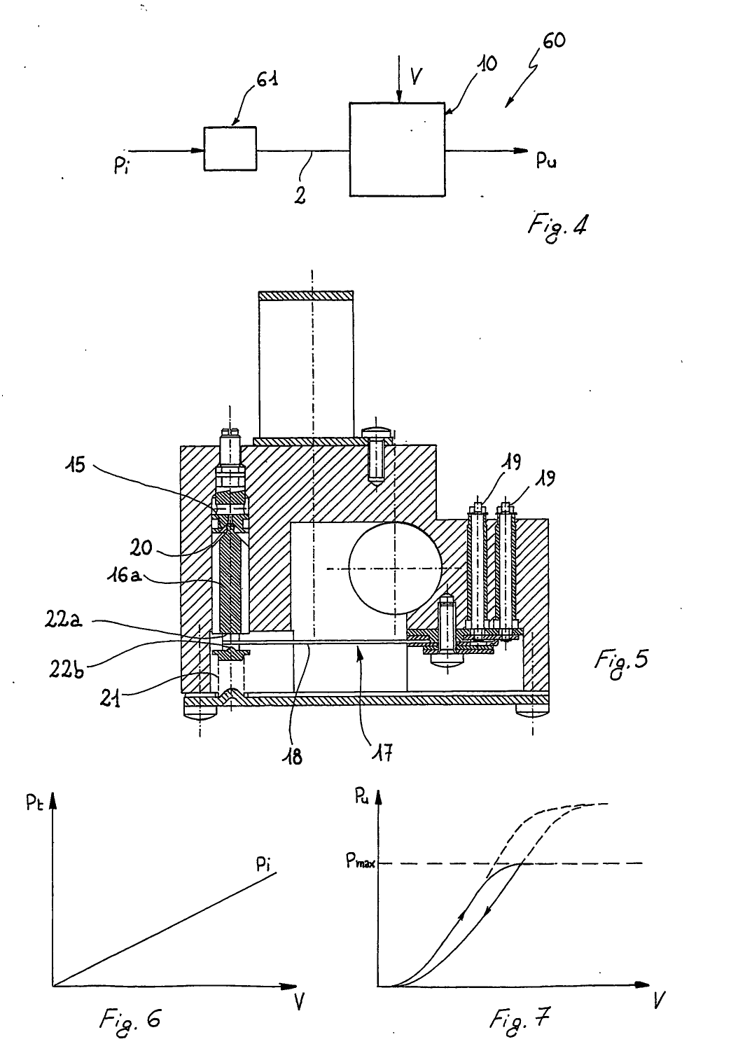

The piezoelectric actuator is connected, at its end 18a, to the body of the closure element 16 and carries, at its opposite end 18b, a pair of terminals 19 for the electrical supply of the actuator. See FIG. 5.

With particular reference to FIG. 5, the closure element 16 has a rod 16a carrying, at one end, a head 20 of the closure element with a curved surface, preferably in the form of a spherical cap, acting on the valve seat 15. At the opposite end, the rod is acted on by a spring 21 for urging the closure element 16 resiliently into closure on the valve seat 15 in opposition to the opening action of the piezoelectric actuator.

The end 18a of the actuator acts between a pair of opposed abutment surfaces 22a, 22b defined by an opening formed in the rod 16a. The distance between the opposed abutments is selected in a manner such that the end 18a of the plate 18 remains spaced from the abutment surface 22b in the absence of an electrical supply to the piezoelectric actuator so as to permit safety closure of the valve seat 15 under the effect of the resilient action of the spring 21 alone in this condition.

The plate 18 of the piezoelectric actuator is selected in a manner such that the displacement brought about in the closure element 16 relative to the valve seat 15 is correlated proportionally with the control signal sent to the actuator, for example, an electrical voltage signal. By virtue of the correlation between the lifting movement of the closure element 16 and the control pressure Pt produced in the control chamber 9, for a pre-selected value of the above-mentioned control signal, a corresponding value of the control pressure Pt is unequivocally generated so that the delivery or output pressure Pu is consequently modulated in a correlated manner.

The graph of FIG. 6 shows a characteristic curve of the control pressure Pt as a function of the supply voltage V of the piezoelectric actuator for a predetermined input pressure Pi in the main duct 2. For example, an almost linear regulation curve Pt-V (and consequently Pu-V) can advantageously be obtained, in which the pressure modulation takes place regularly and precisely for each pre-selected value of the delivery pressure required.

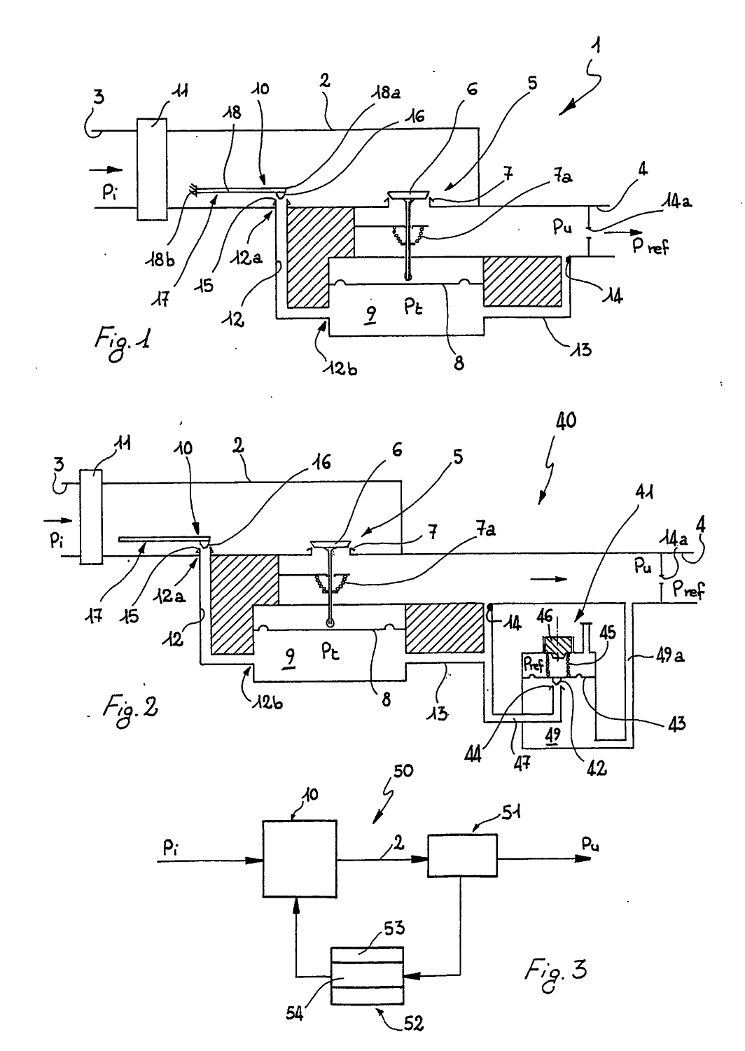

FIG. 2 shows a first variant of the invention, generally indicated 40, in which details similar to those of the previous embodiment are indicated by the same reference numerals. This variant differs from the valve unit 1 mainly in that a maximum delivery-pressure regulator, generally indicated 41 in FIG. 2, is provided downstream of the servo-valve 5. The regulator 41 comprises a closure element 42 controlled by a diaphragm 43 and urged resiliently into closure on a valve seat 44 by the resilient load of a spring 45. The resilient load is adjustable by screwing of a spring holder 46. The valve seat 44 is formed at the end of a duct 47 which is in communication, at its opposite end, with the transfer duct 13. The valve seat in turn is in communication, downstream of the closure element 42, with a chamber 49 communicating with the outlet duct 4 through a duct 49a. The duct 49a opens into the outlet duct 4 downstream of the constriction 14.

Moreover, the closure element 42 can be operated so as to open the respective valve seat 44 by the diaphragm 43 which is sensitive, on the one hand, to the output pressure Pu (acting in the chamber 49) and, on the other hand, to the resilient force of the spring 45, less a reference pressure Pref (acting on the diaphragm 43 from the side remote from the chamber 49), for example, equal to atmospheric pressure. The reference pressure Pref may, for example, be selected so as to be equal to the pressure existing downstream of the delivery nozzle 14a. Upon the assumption that the pressure exerted by the spring 45 can be expressed as the ratio between the resilient force of the spring 45 (equivalent pressure) and an equivalent area of the diaphragm 43, when the output pressure Pu exceeds the equivalent pressure value, the closure element 42 is moved so as to open the valve seat 44, consequently increasing the cross-section for the gas-flow, thus limiting the maximum value of the output pressure Pu to the equivalent pressure value. For values of the output pressure Pu below the equivalent pressure value, the delivery pressure is modulated by the pressure regulator 10, as described above, up to the maximum pressure value which can be reached, which can be set by regulation of the resilient load on the spring holder 46.

In this case, a characteristic curve of the type shown in FIG. 7 is representative of the behaviour of the delivery pressure as a function of the voltage control signal V supplied to the piezoelectric actuator. It will be noted that the maximum delivery pressure is limited to the value (Pmax) set which is adjustable by using the maximum adjustment screw or spring holder 46 of FIG. 2. It is thus possible to achieve a precise adjustment of the maximum output-pressure value.

FIG. 3 shows, through a block diagram, a variant of the invention, generally indicated as the valve unit 50, in which details similar to those of the previous embodiment are indicated by the same reference numerals. This variant differs from the above-described valve unit 1 mainly in that a feedback system is provided in the modulation control of the delivery pressure.

For this purpose, the valve unit 50 is provided with a pressure (or flow-rate) detector with a sensor 51 disposed in the duct 2 downstream of the servo-valve 5, in the region of the outlet opening 4. The valve unit 50 also comprises a feedback control circuit, indicated 52, which is arranged to receive, as an input, a signal correlated with the pressure value detected by the sensor 51. The valve unit 50 also includes a comparison element 53 for comparing the value measured with a preset value relating to a pre-selected pressure (or flow-rate) as well as an element 54 for generating a control signal in dependence on the differential detected and sending it to the piezoelectric actuator so as to regulate the movement of the closure element 16 in order to achieve the desired delivery-pressure value Pu.

It is pointed out that, with the feedback system of the above-mentioned variant, the delivery-pressure value Pu which can be achieved is substantially independent of the input pressure Pi of the gas supply to the valve unit.

In this case, a characteristic curve of the type shown in FIG. 7 is representative of the behaviour of the control chamber pressure Pt as a function of the control signal V, irrespective of any fluctuations or variations of the input pressure Pi.

FIG. 4 shows, in a block diagram, a further variant of the invention, generally indicated as valve unit 60, in which details similar to those of the previous embodiments are indicated by the same reference numerals.

The valve unit 60 differs from the previous variant in that no feedback system is provided but it has a further valve, indicated 61, for regulating the maximum delivery pressure. The valve 61 is disposed upstream of the pressure regulator 10 and is of conventional structure, for example, it is formed with a valve seat and a respective closure element acted on by a diaphragm which is subject to an adjustable resilient load. Adjustment of the resilient load, for example, by screwing of a spring holder, enables a maximum threshold value to be set for the delivery or output pressure Pu which can be reached with modulation of the valve unit.

A regulation curve representative of the valve unit 60 may be, for example, that shown in FIG. 7, including the portions shown by broken lines.

The invention thus achieves the objects proposed, affording the above-mentioned advantages over known solutions.

The main advantage lies in the fact that the valve unit according to the invention ensures improved and more accurate modulation control of the gas-delivery pressure which, moreover, is achieved with a simplified structure of the valve unit in comparison with known solutions.

1. A valve unit for modulating the delivery pressure of a gas, comprising:
a main duct for the delivery of a gas-flow between an inlet opening and an outlet opening;
a servo-valve mounted in the main duct and having a first closure element controlled by a diaphragm, the diaphragm being subjected to the gas-delivery pressure on one side and, on the other side, to a control pressure established in a corresponding control chamber of the servo-valve;
a tapping duct for tapping off the gas delivered to the inlet of the unit, communicating at its two opposite ends with the main duct, upstream of the servo-valve, and with the control chamber, respectively;
a pressure-regulator associated with the servo-valve and including a valve seat mounted in the tapping duct and a respective second closure element associated with the seat; and
piezoelectric actuator associated with the second closure element for the operative control thereof, and a control circuit for generating a control signal for the actuator, whereby the movement of the second closure element relative to the corresponding valve seat is correlated proportionally with the actuator-control signal so that, for a pre-selected signal value, a corresponding control-pressure value is generated so as to modulate the delivery pressure in a proportionally correlated manner.

2. The valve unit according to claim 1 in which the piezoelectric actuator comprises a double-plate element an operative end of which is connected to the second closure element.

3. The valve unit according to claim 2 in which the control signal is a voltage-supply signal for the piezoelectric actuator.

4. The valve unit according to claim 3 further comprising:
means for detecting the delivery pressure downstream of the servo-valve, and
comparison means for comparing the detected delivery-pressure value with a pre-selected value and consequently generating a corresponding control signal for the piezoelectric actuator so as to modulate the delivery pressure in order to achieve the pre-selected pressure value.

5. The valve unit according to claim 4 in which the detector means and the comparison means constitute a feedback circuit acting on the pressure regulator.

6. The valve unit according to claim 5 in which the detector means is arranged to detect the flow-rate of gas delivered.

7. The valve unit according to claim 6, further comprising a further valve for regulating the maximum delivery pressure, disposed upstream of the servo-valve and of the pressure-regulator.

8. The valve unit according to claim 1 in which the control signal is a voltage-supply signal for the piezoelectric actuator.

9. The valve unit according to claim 8 further comprising:
means for detecting the delivery pressure downstream of the servo-valve, and
comparison means for comparing the detected delivery-pressure value with a pre-selected value and consequently generating a corresponding control signal for the piezoelectric actuator so as to modulate the delivery pressure in order to achieve the pre-selected pressure value.

10. The valve unit according to claim 9 in which the detector means and the comparison means constitute a feedback circuit acting on the pressure regulator.

11. The valve unit according to claim 10 in which the detector means is arranged to detect the flow rate of gas delivered.

12. The valve unit according to claim 11, further comprising a further valve for regulating the maximum delivery pressure, disposed upstream of the servo-valve and of the pressure regulator.

13. The valve unit according to claim 1 further comprising:
means for detecting the delivery pressure downstream of the servo-valve, and
comparison means for comparing the detected delivery-pressure value with a pre-selected value and consequently generating a corresponding control signal for the piezoelectric actuator so as to modulate the delivery pressure in order to achieve the pre-selected pressure value.

14. The valve unit according to claim 13 in which the detector means and the comparison means constitute a feedback circuit acting on the pressure regulator.

15. The valve unit according to claim 14 in which the detector means is arranged to detect the flow rate of gas delivered.

16. The valve unit according to claim 15, further comprising a further valve for regulating the maximum delivery pressure, disposed upstream of the servo-valve and of the pressure regulator.

17. The valve unit according to claim 1, further comprising a further valve for regulating the maximum delivery pressure, disposed upstream of the servo-valve and of the pressure regulator.

18. The valve unit according to claim 2, further comprising a further valve for regulating the maximum delivery pressure, disposed upstream of the servo-valve and of the pressure regulator.

19. The valve unit according to claim 3, further comprising a further valve for regulating the maximum delivery pressure, disposed upstream of the servo-valve and of the pressure regulator.

20. The valve unit according to claim 4, further comprising a further valve for regulating the maximum delivery pressure, disposed upstream of the servo-valve and of the pressure regulator.
